(19) United States
(12) Patent Application Publication
(10) Pub. No.: US 2007/0084255 A1
(43) Pub. Date: Apr. 19, 2007

(54) Restraining-protecting-lifting device and method

(76) Inventor: Paul Otto, Birmingham, AL (US)

Correspondence Address: GEORGE R. REARDON, 3356 STATION COURT, LAWRENCVILLE, GA, 30044, US

(21) Appl. No.: 11/242,211

(22) Filed: Oct. 3, 2005

(51) Int. Cl. E05B 75/00

(52) U.S. Cl. 70/16

(57) ABSTRACT

The present invention relates generally to multi-purpose devices. In particular, the present invention relates to devices that can be used as a restraint by engaging the arms and legs of the desired person or animal; as a protective device by distracting an assailant with pain from striking his/her skin, or throwing the device at the assailant; as a lifting device by sliding the invention onto an arm or leg of a person or animal, then lifting.

### FIELD OF THE INVENTION

The present invention is directed to multi-purpose devices that can be used for restraining, protecting and lifting. More particularly, this invention relates to multi-purpose devices designed for engaging the extremities of a body, e.g. the arms and legs of a person, or an animal.

### BACKGROUND OF THE INVENTION

This invention relates in general to a lightweight, flexible, easily concealed, rapidly deployable device which may be utilized for a variety of purposes: to engage the extremities of a person or animal, e.g. arms and legs of a person or animal, for the purpose of restraining or limiting the mobility of such a person or animal; as a self-defense device that is held by fingers then swung to distract the attacker with stinging pain, to be thrown at the attacker; to engage the extremities of a person or animal for the purpose of facilitating the lifting of the extremities.

Historically a variety of restraining devices have been used to immobilize persons or limit their mobility. Those devices have included the type wherein size or weight of the restraining device is the primary factor in immobilizing or restraining the person sought to be controlled. Other devices have been permanently secured in a fixed configuration, and the person sought to be restrained is bound thereto. Such restraining devices are utilized after the person sought to be restrained has been brought, under control, to the device and generally are not suitable for being carried by a person seeking to control or restrain another. These aforementioned devices were used primarily where the person sought to be restrained was under the control of another person. The devices being used to immobilize the person are applied after control is established.

Currently law enforcement personnel carry devices which may be utilized to immobilize or restrain a person being taken into custody. Such devices are used for establishing control over a person being taken into custody, as well as to maintain that control once custody has been established. Handcuffs and thumb-cuffs are the most common of these devices currently in use. While these devices are suitable for their intended purposes the size and weight of such restraining devices limit the number which can be carried by a law enforcement officer. In addition, it has been found that such devices have been used as weapons against the law enforcement officers by the person being restrained; both when attempting to control such person and after the devices have been secured in place. Additionally, law enforcement personnel frequently injure a detainee's joints or skin regularly using traditional methods of restraint. Non-law enforcement officers also have a need for lightweight, flexible and easily concealable restraining device. Such devices are for those engaging in bondage behavior, plus those apprehensive about being accosted. Further, nursing, therapy staff and emergency personnel frequently have a need to lift the extremities of a person, and may want an option that minimizes personal contact, e.g. eliminates skin-contact exposure to infectious disease when blood is present.

Attempts to resolve some of these problems include Charland U.S. Pat. No. 4,854,138, which discloses a flexible braid of a soft, strong material, such as a flat braided nylon, utilized to engage a locking block which permits the braided material to pass freely in one direction, but which prevents movement of the material in an opposite direction. In this manner the braided material, which is formed in an endless loop, may be placed about the extremities of a person whose movement is sought to be controlled or restrained, and the loop tightened. The flexible material will tightly encircle the extremities sufficient to control or restrain their movement, but will not cut or gouge the person being restrained unless such person attempts to remove the restraining device. Because of the lightweight and inexpensive nature of the restraining device a law enforcement officer can comfortably and conveniently carry a number of these devices when on duty to facilitate arrests and control of multiple offenders.

Another attempt to resolve some of these problems include Schubach U.S. Pat. No. 3,426,559, which discloses a prisoner restraining device including an elongated flexible cord for connecting the wrists or ankles of a prisoner, forming two loops at its opposite ends to receive the ankles or wrists, with the cord having a small terminal loop at one of its extremities received about an intermediate portion of the cord to form a first of the loops, and with the cord carrying a snap hook at its opposite end detachable connectable to an intermediate portion of the cord to form the second loop, and further with the flexible member and its terminal eye and snap hook having a combined overall length of between about 27 inches and 33 inches.

None of these devices are designed to have the versatility of also being used as a lifting device or as a self-protection device. None of these devices are designed to be easily concealed on a person or to be capable of rapid retrieval and deployment. Other problems exist that are not addressed by these devices. Therefore, improvements are needed over the existing solutions.

The present invention provides a restraining-protecting-lifting device which is inexpensive, lightweight and more comfortable for the person sought to be controlled or lifted while having a distractive aspect when utilized for self-protection. A major object of the present invention is to provide a device which can be applied relatively easily to arms or legs, but without danger of cutting or damaging skin. In using the present invention, it is desired to temporarily provide a cuff on an arm to facilitate application of conventional hand cuffs or take the place of them. After the suspect has been subdued and placed under control in this manner hand cuffs should be placed on the wrists to more permanently secure the wrists. The present linked hoop device will function as a duel leg and arm restraint able to accept attachment of hand cuffs or single restraint hoops (from the other arm).

It is an object of the present invention to provide a restraining-protecting-lifting device that is hand-held.

Still another object of the present invention is to provide a restraining-protecting-lifting device that is easy to use.

Yet another object of the present invention is to provide a restraining-protecting-lifting device that can be made inexpensively.

It is a further object of the present invention to provide a restraining-protecting-lifting device that can be used for restraint of the extremities, e.g., arms, legs.

It is a further object of the present invention to provide a restraining-protecting-lifting device that can be used to facilitate the lifting of the extremities, e.g. arms or legs of a person in a nursing, hospital or therapy environment, or at an emergency medical situation.

It is a further object of the present invention to provide a restraining-protecting-lifting device that can be used as a self-protection device, e.g. holding the invention while snapping an assailant's vital areas, or by throwing the invention at the person's face.

It is a further object of the present invention to provide a restraining-protecting-lifting device that can be easily concealed, e.g. inside clothing, or a handbag.

It is a further object of the present invention to provide a restraining-protecting-lifting device that is capable of being manufactured by existing machinery, with moderate adaptation, or that may be handmade by personnel.

### SUMMARY OF THE INVENTION

The aforementioned and other objects were achieved, and the above-mentioned disadvantages overcome, by the present invention, by providing a restraining-protecting-lifting device that can be used to immobilize a person or animal, snap an assailant while holding the invention with fingers, or by throwing the invention at a person, and to facilitate the lifting of the extremities of a person or animal.

The present invention is directed to a hand-deployed multi-use device. In a preferred embodiment of the invention the restraining-protecting-lifting device is comprised of a generally hoop-shaped body of material.

The present invention is comprised of at least one hoop-shaped body of material. The hoop-shaped body of material is generally comprised of an inner core and an outer casing. The inner core may be made of a uniform, single material, or strands of several materials. When several materials are used, these materials may be wound around a base of a solid hoop-shaped material or they may be wound or arranged without the use of a base. The winding pattern may vary, e.g. uniform, non-uniform, one strand, multiple strand layers, all strands being wound in the same direction, or strands being wound in opposite directions. Additionally, the inner core may be made of a plurality of hoops. These hoops may be of a uniform solid material or may be of a uniform solid material having one or more materials wound around one or more hoops in a uniform pattern. The outer casing is made from a durable material that can be easily cleaned, e.g. vinyl. An alternative configuration is to enclose the single or multi-strand core. with a product similar to round boot laces. The encircling laces spiral linearly along the circumference of the hoop's core until the ends meet. There is an intersection where the ends meet. This is the fusion point. Fusion of the splice is achieved with a durable, soft, and permanent product. Similar products to clear silicone adhesives are desired

In one embodiment the present invention is further comprised of padding. A padding layer is disposed between the inner casing and outer vinyl covering. In another embodiment of the present invention the padding is disposed on the outside the vinyl covering on the inside of the hoop-shaped material. In still another embodiment of the present invention the padding is disposed on the outside of the vinyl covering as a crescent shape on the inside of the hoop-shaped material.

In another embodiment the present invention is further comprised of non-releasable attaching means and deployment means. The attaching means may take the form of a circular band though which the hoop-shaped material is threaded. The deployment means may take the form of a string or cord, which may or may not terminate in a loop.

In another embodiment the present invention is further comprised of releasable attaching means. The releasable attaching means may take the form of a male connector integrated into the hoop-shaped material, along with a female connector that is affixed to a string or cord.

In another embodiment of the present invention, two hoop-shaped materials are slideably linked together. The two hoop-shaped materials may be of different sizes, e.g. one may be sized for a wrist and the other for an ankle, or they may be the same size, e.g. for both wrists, or for both ankles. The present linked hoop device can function as a duel leg and arm restraint able to accept attachment of hand cuffs or single restraint hoops (from the other arm).

In another embodiment of the present invention, two hoop-shaped materials are combined, the flexible link with two poly hood ends is slideably attached by encircling the primary hoop, and disposed for releasable engaging of a second hoop.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principles thereof, and in which:

FIG. 1 shows a perspective view of a restraining-protecting-lifting device according to an embodiment of the present invention.

FIG. 2 shows a perspective view of a restraining-protecting-lifting device showing a cut-out section that is detailed in FIG. 3 according to an embodiment of the present invention.

FIG. 3 shows a detailed view of the cut-out section from FIG. 2 of a restraining-protecting-lifting device according to an embodiment of the present invention.

FIG. 4 shows a detailed view of a method of weaving stands of material together as one of the steps of making an embodiment of the present invention.

FIG. 5 shows a perspective view of a restraining-protecting-lifting device showing a cross-section that is detailed in FIG. 6 according to an embodiment of the present invention.

FIG. 6 shows a cross-sectional view according to an embodiment of the present invention.

FIG. 7 shows a plurality of cross-sectional views according to embodiments of the present invention.

FIG. 8 shows a perspective view of a restraining-protecting-lifting device showing a cut-out section that is detailed in FIG. 9 according to an embodiment of the invention.

FIG. 9 shows a detailed view of the fusing together of strands of material, according to an embodiment of the present invention.

FIG. 10 shows a plan view of a restraining-protecting-lifting device showing a cut-out section that is detailed in FIG. 11 according to an embodiment of the present invention.

FIG. 11 shows a detailed view of the section from FIG. 10 of a restraining-protecting-lifting device according to an embodiment of the present invention.

FIG. 12 shows a plan view of a restraining-protecting-lifting device showing a cut-out section that is detailed in FIG. 13 according to an embodiment of the present invention.

FIG. 13 shows a detailed view of the section from FIG. 12 of a restraining-protecting-lifting device according to an embodiment of the present invention.

FIG. 14 shows a plan view of a restraining-protecting-lifting device showing a cut-out section that is detailed in FIG. 15 according to an embodiment of the present invention.

FIG. 15 shows a detailed view of the section from FIG. 14 of a restraining-protecting-lifting device according to an embodiment of the present invention.

FIG. 16 shows a plan view of a restraining-protecting-lifting device showing a cut-out section that is detailed in FIG. 17 according to an embodiment of the present invention.

FIG. 17 shows a detailed view of the section from FIG. 16 of a restraining-protecting-lifting device according to an embodiment of the present invention.

FIG. 18 shows the use of multiple embodiments of the present invention along with accessories to the present invention, with cutouts showing detail in FIG. 21 and FIG. 22.

FIG. 19 shows the use of two distinct embodiments of the present invention linked together.

FIG. 20 shows an arrangement linking together two embodiments of the present invention.

FIG. 21 shows preferred dimensions for a linking arrangement.

FIG. 22 shows a plan view of a linking arrangement engaging an embodiment of the present invention.

FIG. 23 shows one method of engaging one embodiment of the present invention to another embodiment of the present invention.

FIG. 24 shows one scenario using multiple embodiments of the present invention.

FIG. 25 shows multiple scenarios using multiple embodiments of the present invention, as well as an accessory for the present invention.

FIG. 26 shows another view of a scenario using multiple embodiments of the the present invention.

FIG. 27 shows another view of another scenario using multiple embodiments of the present invention.

FIG. 28 shows another view of yet another scenario using multiple embodiment of the present invention.

FIG. 29 is a plan view showing a cutout for giving further detail in FIG. 30 and FIG. 31, according to an embodiment of the present invention.

FIG. 30 shows detail of the material elements, according to an embodiment of the present invention.

FIG. 31 shows a cross-sectional view of an embodiment of the present invention.

FIG. 32 shows an embodiment of the present invention.

FIG. 33 shows elements of an embodiment of the present invention.

FIG. 34 shows a use of an embodiment of the present invention using slideably linked elements to muzzle a dog.

FIG. 35 shows a use of an embodiment of the present invention to hobble a horse.

FIG. 36 shows a scenario of equipping a person with embodiments of the present invention, with cutouts for showing further detail in FIG. 37, FIG. 38, FIG. 45, and FIG. 46.

FIG. 37 shows detail of an embodiment of the present invention being stowed in a pants pocket for easy access when needed.

FIG. 38 shows detail of an arrangement for holding and accessing an embodiment of the present invention.

FIG. 39 shows detail of an arrangement for holding and accessing an embodiment of the present invention.

FIG. 40 shows a scenario of equipping a person with embodiments of the present invention, with cutouts for showing further detail in FIG. 37, FIG. 41, FIG. 42, FIG. 43, FIG. 44, FIG. 45 and FIG. 46.

FIG. 41 shows detail of an arrangement for holding and accessing an embodiment of the present invention.

FIG. 42 shows detail of an arrangement for holding and accessing an embodiment of the present invention.

FIG. 43 shows detail of an arrangement for holding and accessing an embodiment of the present invention.

FIG. 44 shows detail of an arrangement for holding and accessing an embodiment of the present invention.

FIG. 45 shows the movement to deploy an embodiment of the present invention that is stowed up a shirt sleeve.

FIG. 46 shows detail of an arrangement for holding and accessing an embodiment of the present invention.

FIG. 47 shows a detailed view of the section from FIG. 10 of a restraining-protecting-lifting device according to an embodiment of the present invention.

### DETAILED DESCRIPTION OF THE INVENTION

The drawings show aspects of the invention. As the drawings are described, reference will be made to the present preferred embodiments of the invention. The terminology used herein to describe the present preferred embodiments is for the purpose of clarification. The invention, however, is not intended to be limited to the specific terminology used. Terminology used to describe each element should be understood to include all technical equivalents that operate in a similar manner to accomplish similar functions.

The present invention is described in relation to restraining-protecting-lifting device. Nonetheless, the characteristics and parameters pertaining to various embodiments the device and methods described herein may be applicable for other uses.

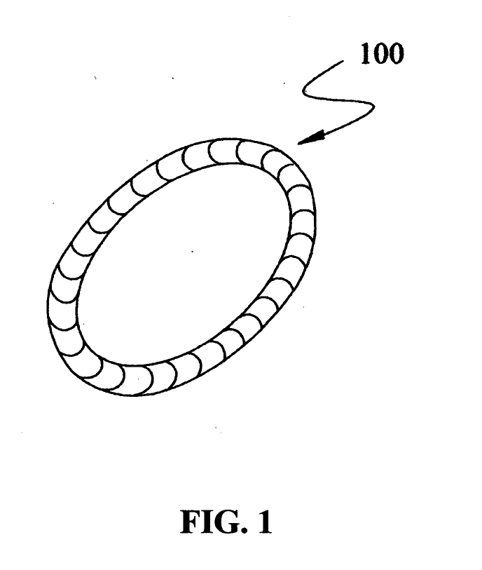

Referring to FIG. 1, an embodiment of the present invention is shown as device 100.

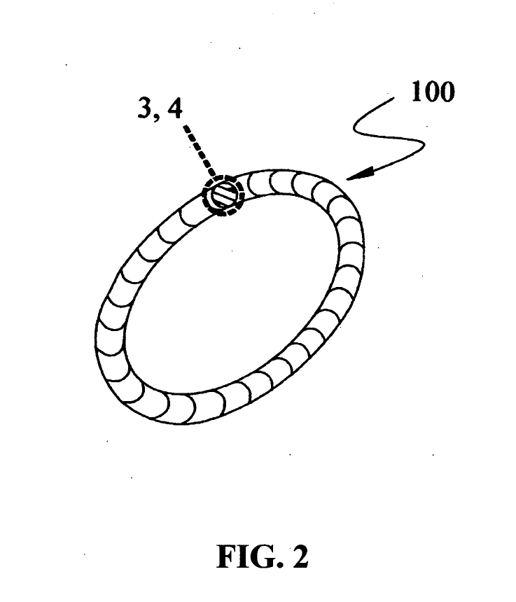

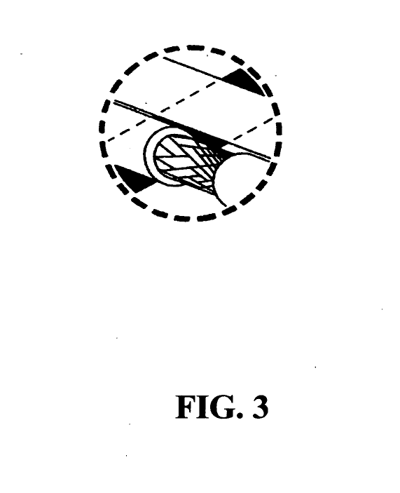

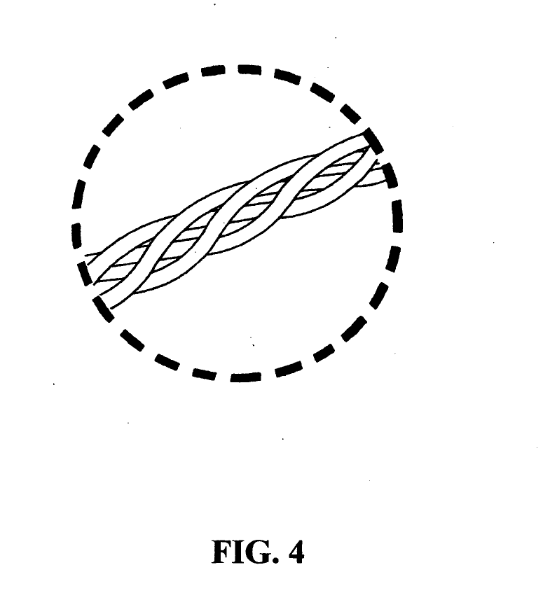

Referring to FIG. 2, device 100 is shown with a cut-out section in order to give more detail in FIG. 3 and FIG. 4 to the inner core 10, filler cushion inserts 20, cloth separation layer 30 and seamless antiseptic outer coating 60.

Referring now to FIG. 3, detail is shown of the materials used in construction.

Referring now to FIG. 4, one embodiment of the weaving of the strands is shown wherein device 100 has a spiraling core.

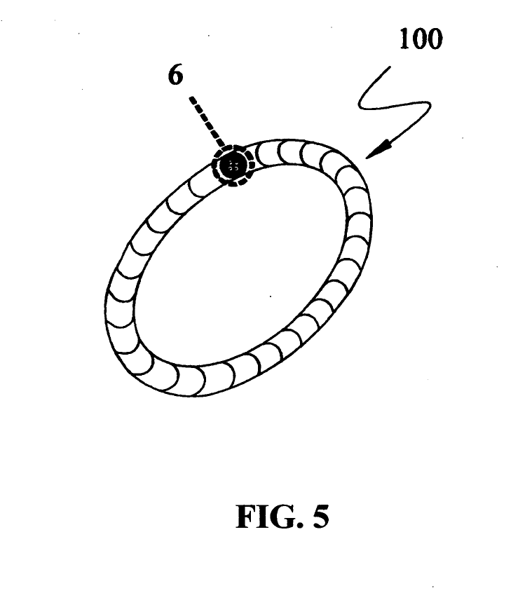

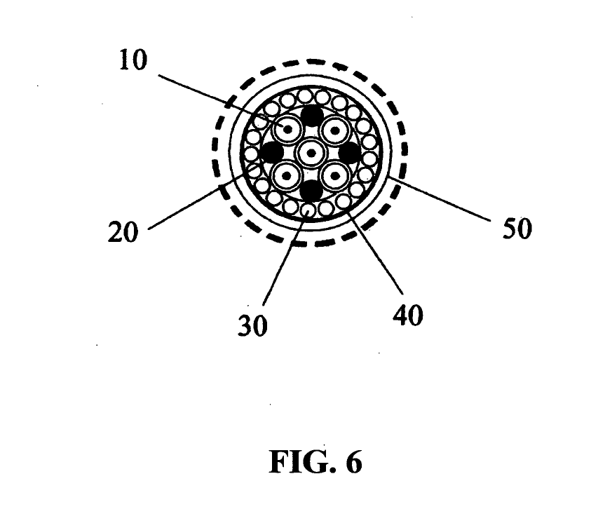

Referring now to FIG. 5, device 100 is shown with a cut-out section in order to give more detail in FIG. 6.

Referring to FIG. 6, the construction of an embodiment of device 100 is shown as comprised of inner core 10, filler cushion insert 20, cloth separation layer 30, polyester cloth layer with seams 40, seamless antiseptic outer coating 50.

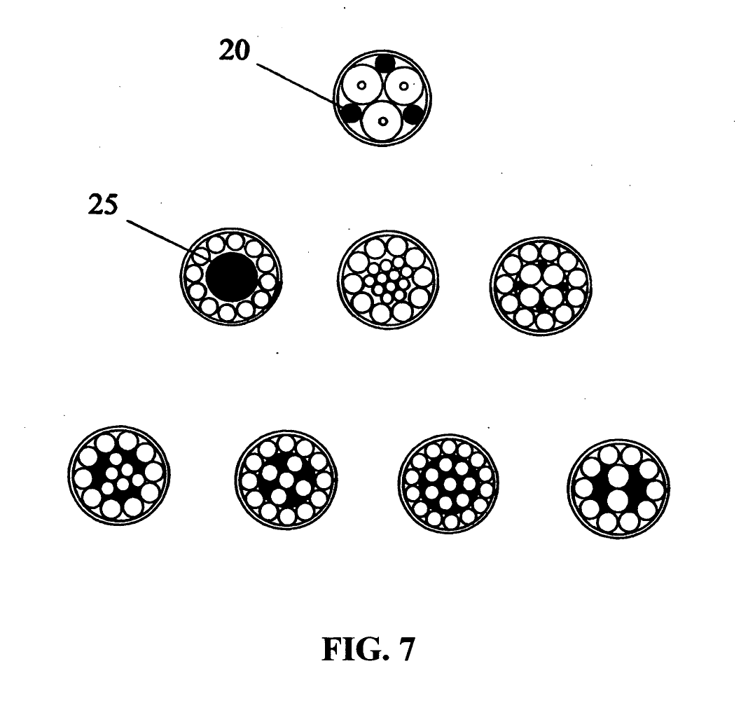

Referring now to FIG. 7, various arrangements of filler cushion insert 20, solid cushion core 25 are shown.

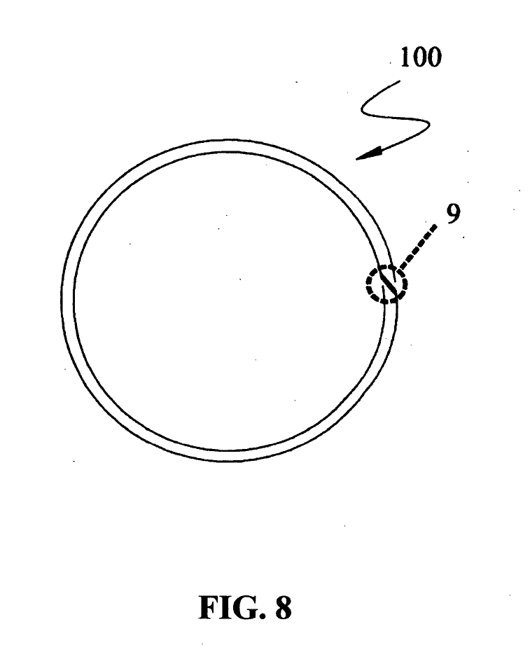

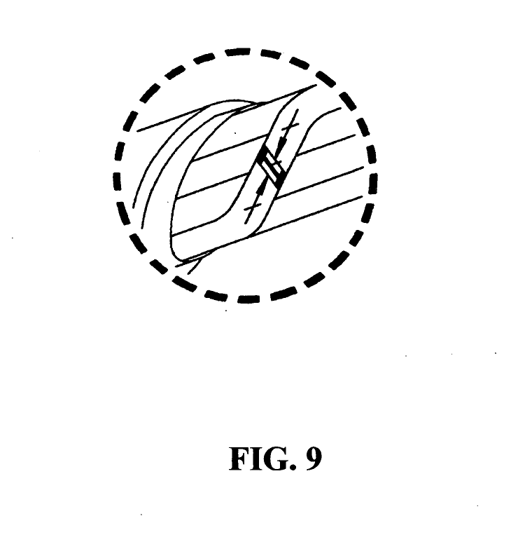

Referring to FIG. 8, device 100 is shown with a cut-out section in order to give more detail in FIG. 9.

Referring now to FIG. 9, one embodiment of the joining of the strands is shown.

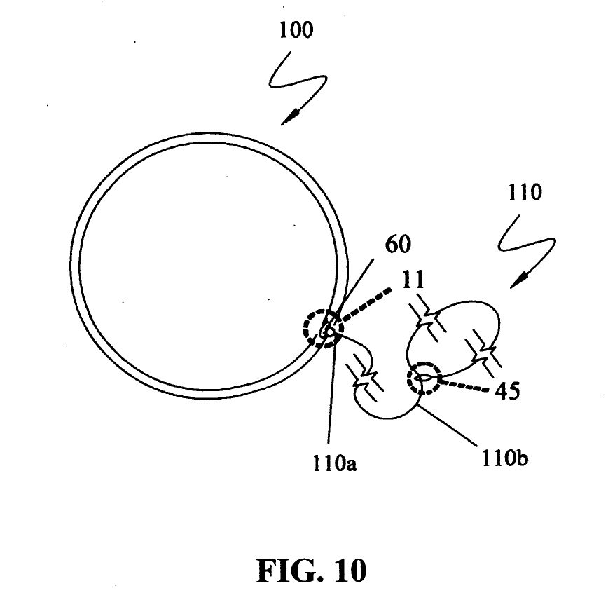

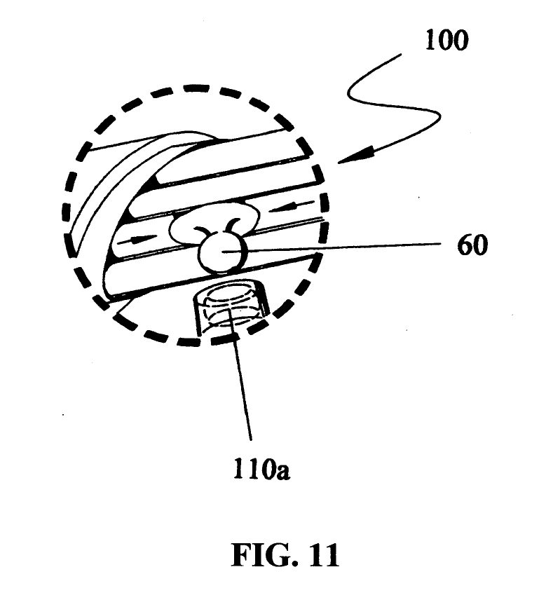

Referring now to FIG. 10, device 100 is shown with a cut-out section in order to give more detail in FIG. 11. In this embodiment, tether 120 is shown with parts female end 110a and flexible cord 110b, and male connector 60.

Referring now to FIG. 11, male connector 60 is shown ready to click into female end 110a.

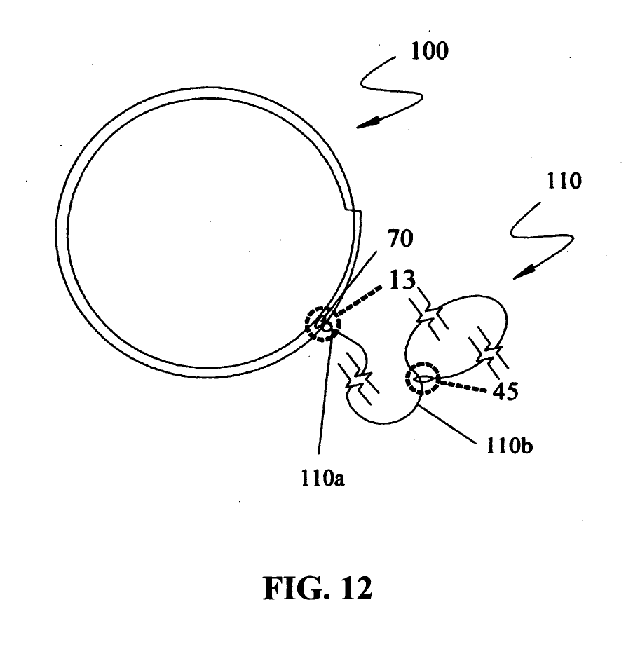

Referring now to FIG. 12, device 100 is shown. In this embodiment, device 100 is further comprised of strap-on male assembly 70, namely raised ball 70a, tether 110, female end 110a, flexible cord 110b. A cut-out section is shown on device 100 in order to give more detail in FIG. 11.

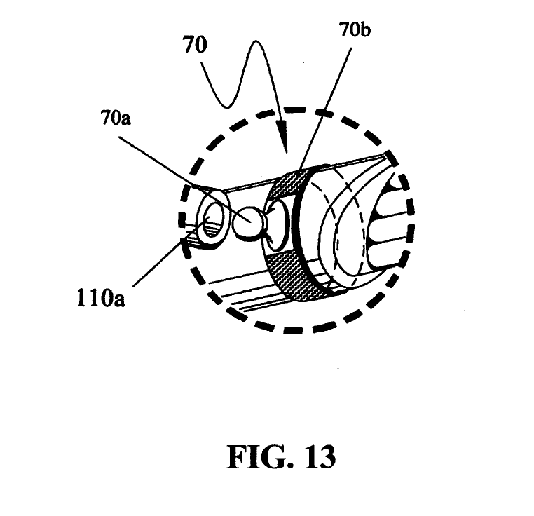

Referring to FIG. 13, detail is shown of strap-on male assembly 70, namely raised ball 70a and encircling webbed strap 70b, shown about to be secured to flexible cord 110a.

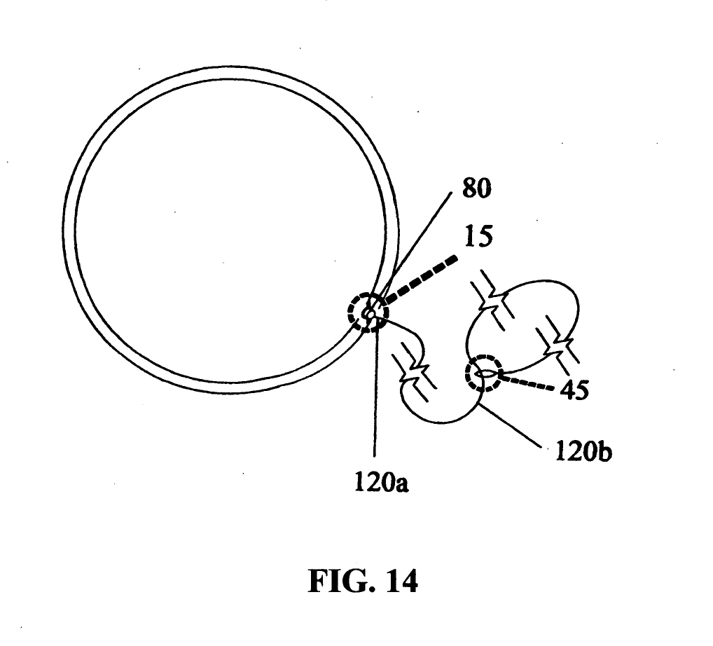

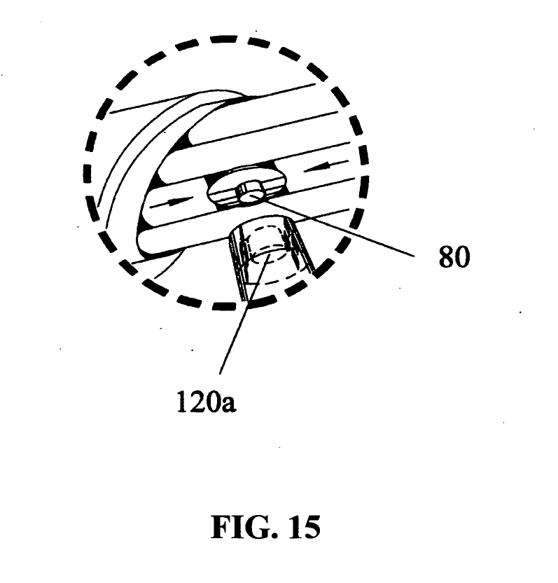

Referring to FIG. 14, device 100 is shown with a cut-out section in order to give more detail in FIG. 15. In this embodiment, magnetic tipped tether 120 is shown with parts female magnetic tip 120a and flexible cord 120b, and male connector 80.

Referring to FIG. 15, detail is shown of female magnet tip 120a about to be secured to male magnetic connector 80.

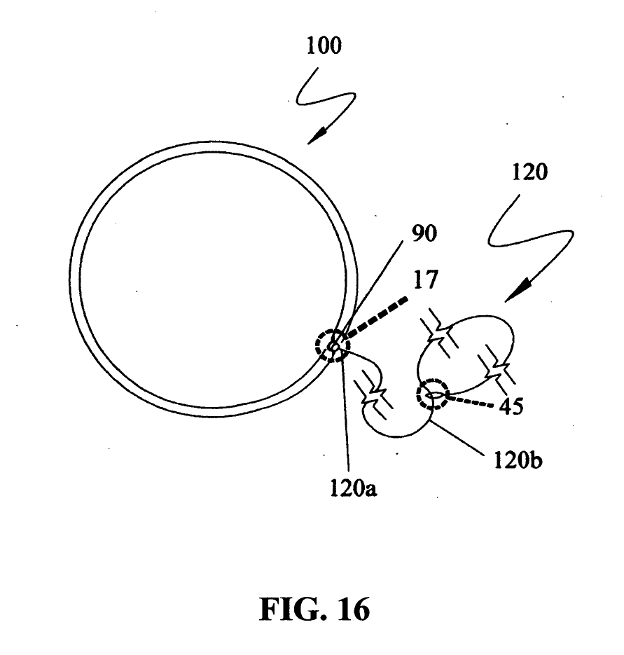

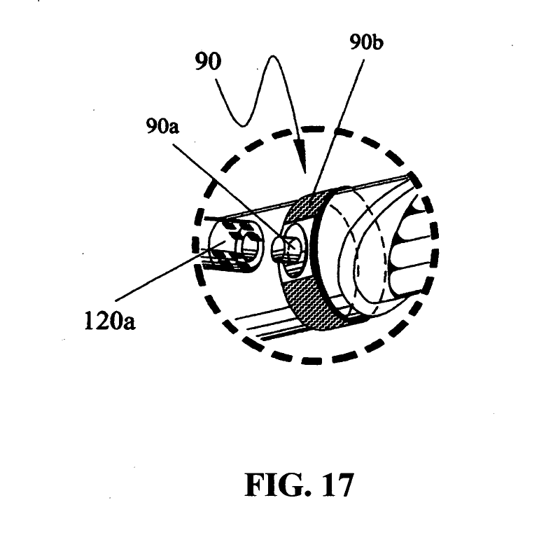

Referring to FIG. 16, device 100 is shown with a cut-out section in order to give more detail in FIG. 17. In this embodiment, magnetic tipped tether 120 is shown with parts female magnetic tip 120a and flexible tether 120b, and male magnetic webbed strap connector 90

Referring to FIG. 17, detail is shown of female magnetic tip 120a about to be secured to male magnetic tip 90a. Also shown is encircling webbed strap 90b.

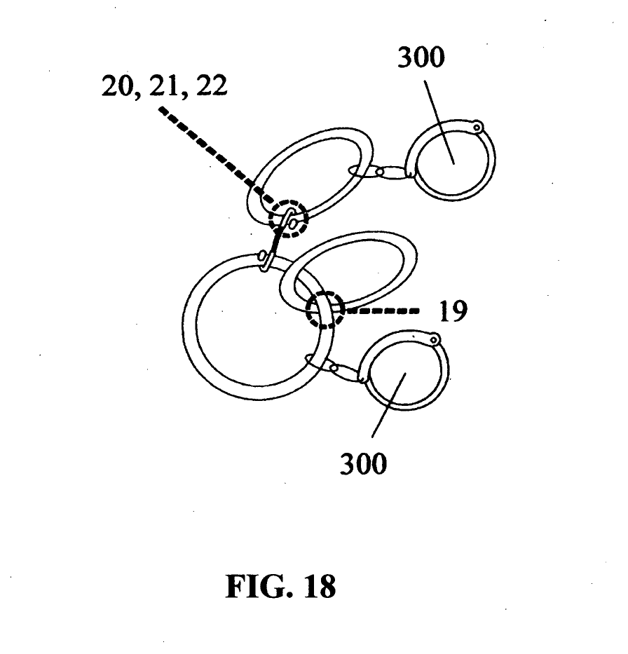

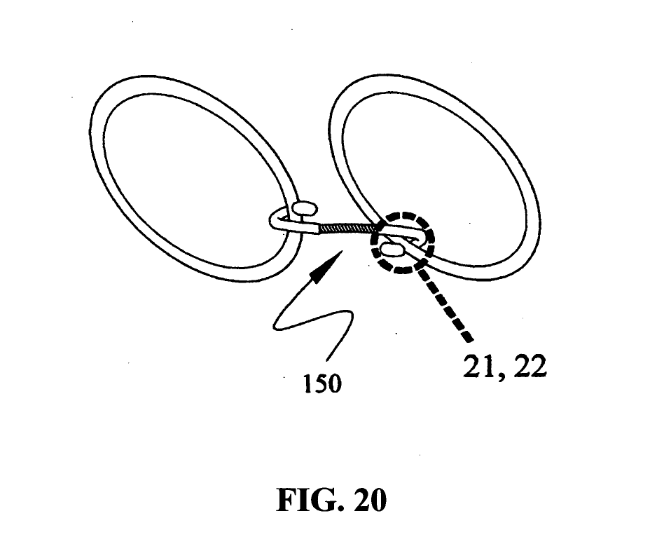

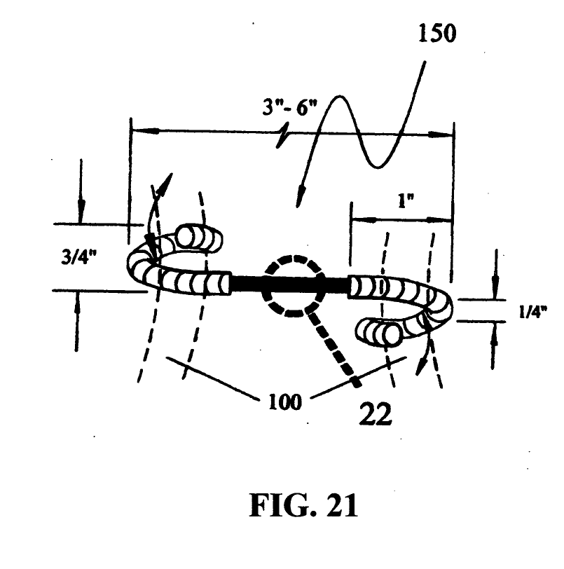

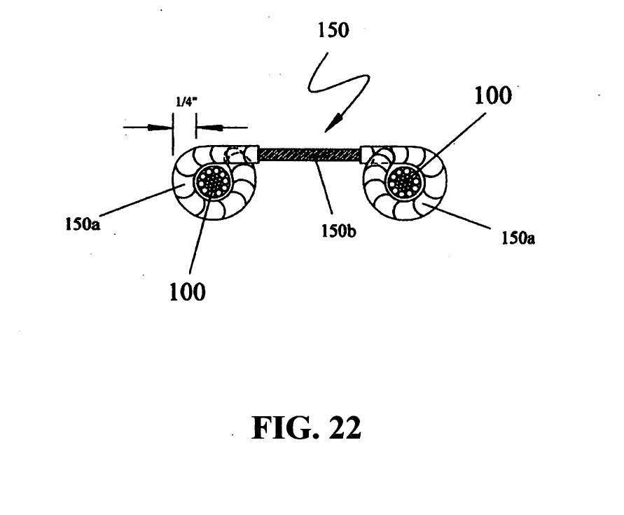

Referring to FIG. 18, linked single handcuff 300, flexible link 150 is shown with cut-out sections in order to give more detail in FIG. 20, FIG. 21 and FIG. 22.

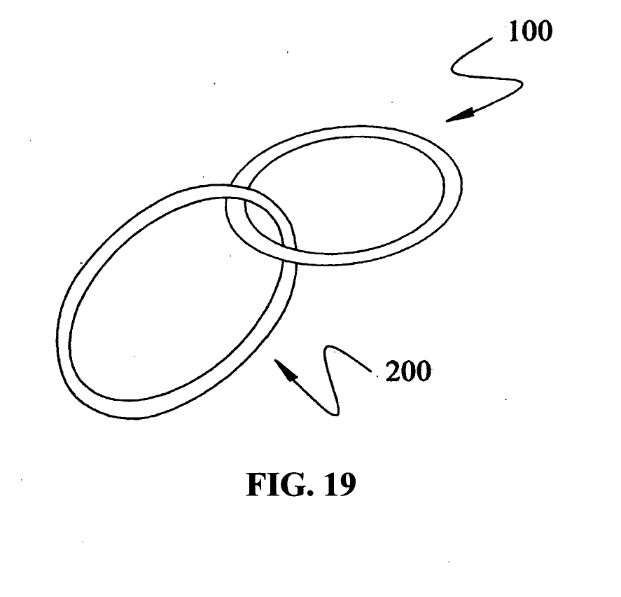

Referring to FIG. 19, device 100 is shown with larger or smaller device 200.

Referring to FIG. 20, flexible link 150 is shown.

Referring to FIG. 21, plan view detail is shown of flexible link 150.

Referring to FIG. 22, side view detail is shown of flexible link 150 is shown, comprising moveable end 150a and flexible cord 150b. Device 100 is also shown.

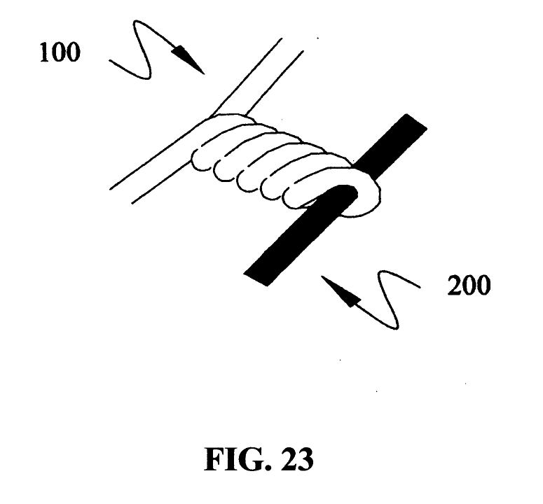

Referring to FIG. 23, device 100 is shown connected to larger or smaller device 200.

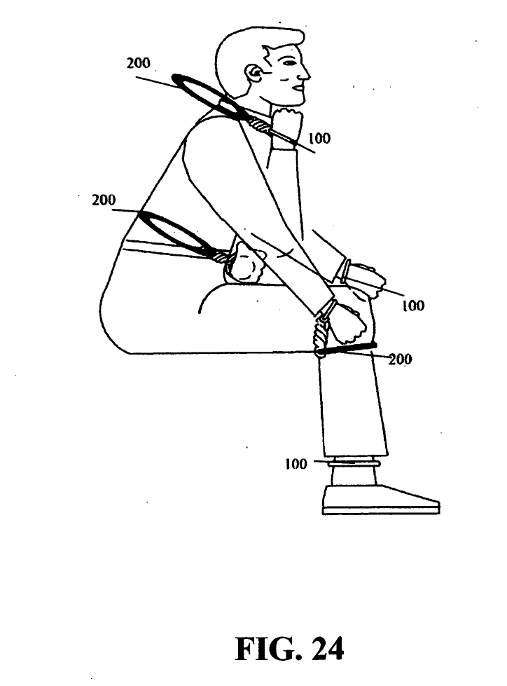

Referring to FIG. 24, one use of multiples of device 100 and larger or smaller device 200 is shown.

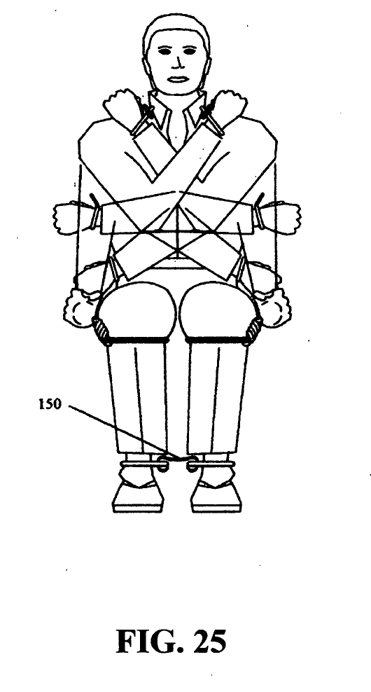

Referring to FIG. 25, another view of the use of multiples of device 100 and larger or smaller device 200 are shown, as is flexible link 150.

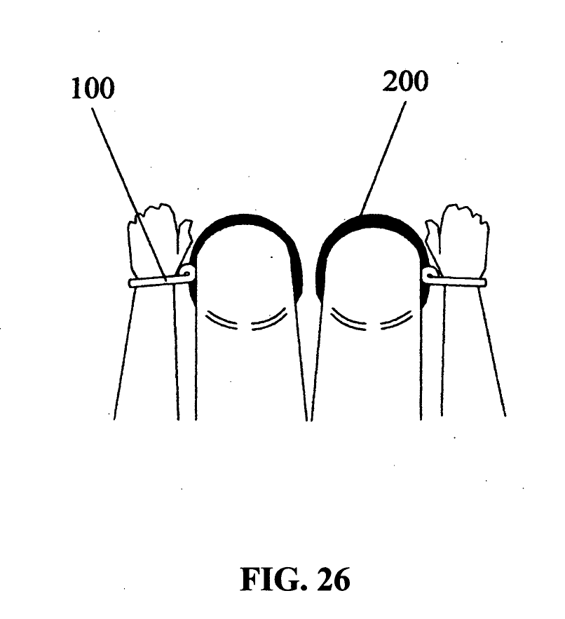

Referring to FIG. 26, another view of the use of device 100 and larger or smaller device 200 are shown.

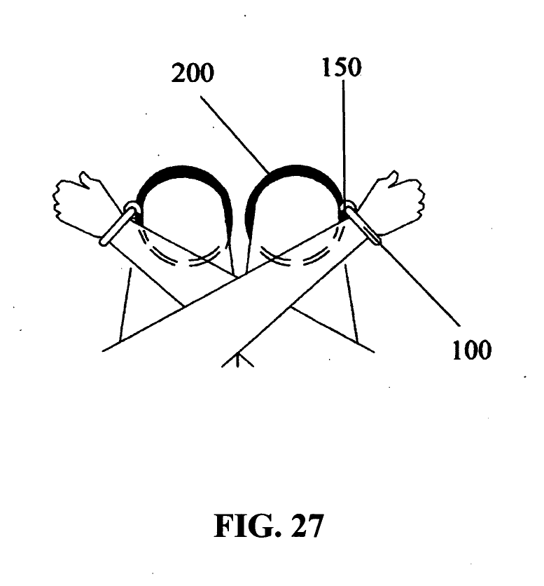

Referring to FIG. 27, another configuration using device 100 and larger or smaller device 200, in conjunction with flexible link 150 is shown.

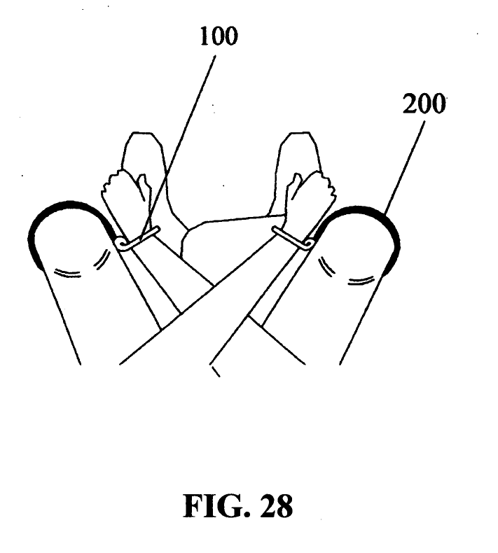

Referring to FIG. 28, another configuration using device 100 and larger or smaller device 200 is shown.

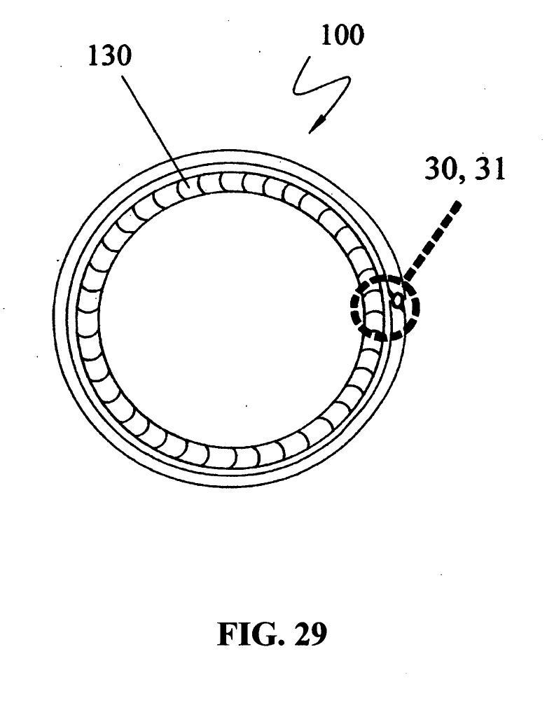

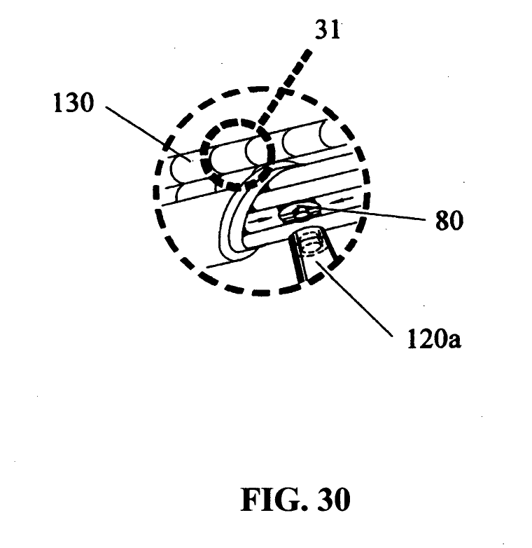

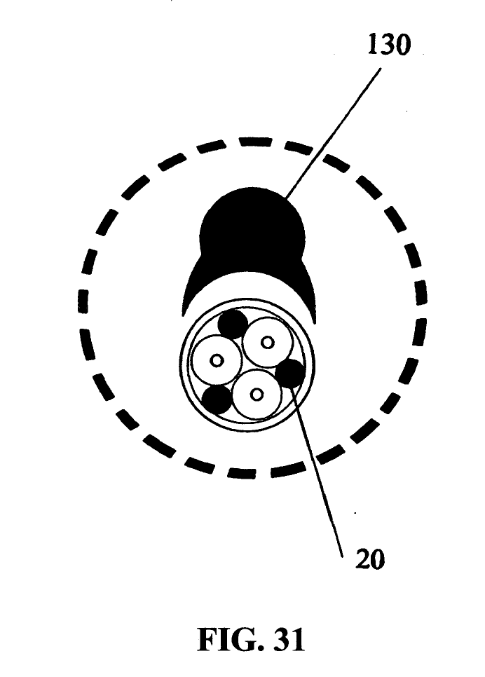

Referring to FIG. 29, device 100 is shown, with cushion 130 and a cutout in order to show further detail in FIG. 30 and FIG. 31.

Referring to FIG. 30, cushion 130 is shown in detail, highlighting male connector 90 and female magnetic tip 120a. A cutout is also shown to give further detail in FIG. 31.

Referring to FIG. 31, detail of cushion 130 is shown, with filler cushion inserts 20.

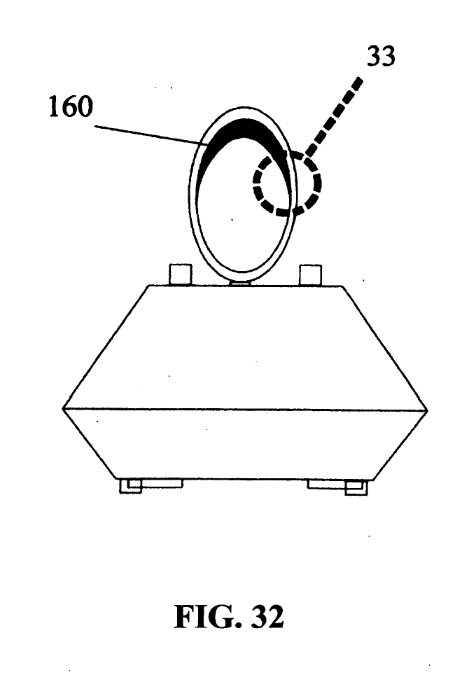

Referring to FIG. 32, cushion 160 is shown.

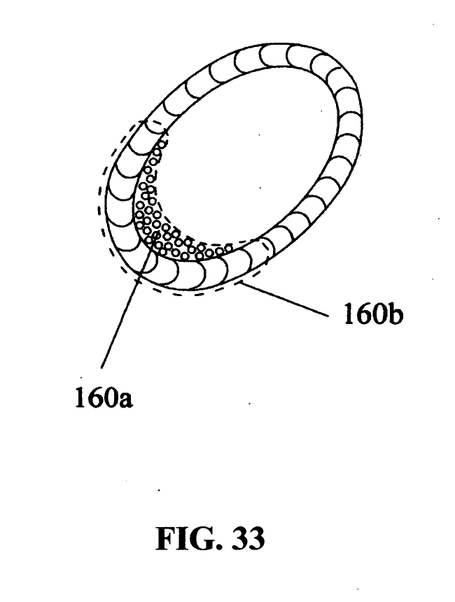

Referring to FIG. 33, cushion 160 is shown being comprised of covering 160a and foam rubber 160b.

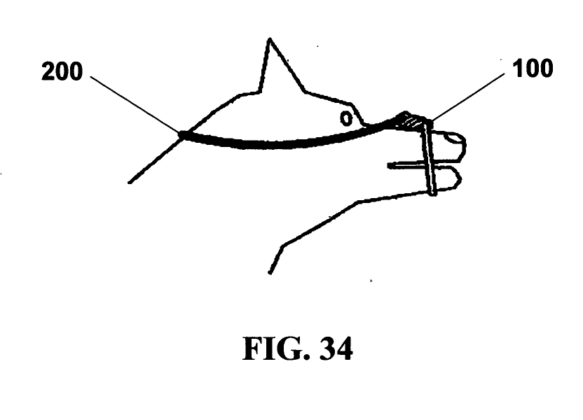

Referring to FIG. 34, another use of the present invention is shown to muzzle a dog, using device 100 slideably connected to larger or smaller device 200.

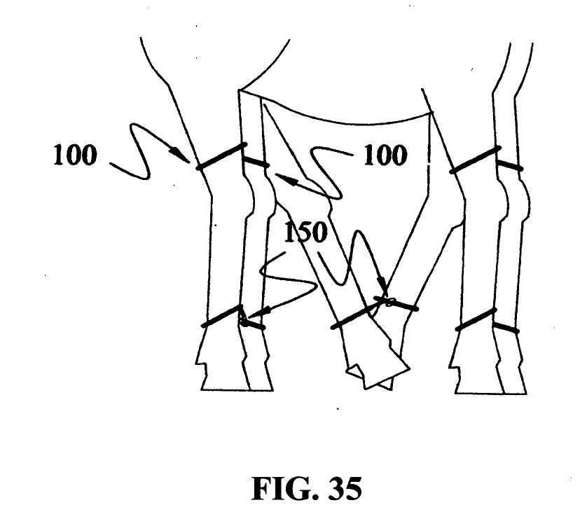

Referring to FIG. 35, another use of the present invention is shown to hobble a horse.

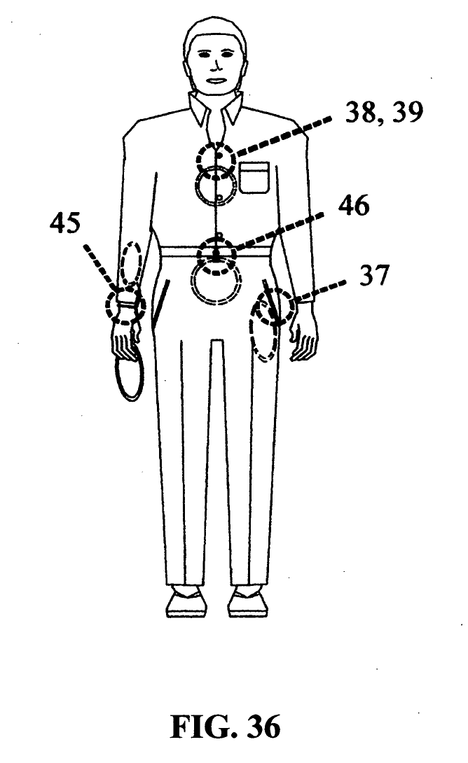

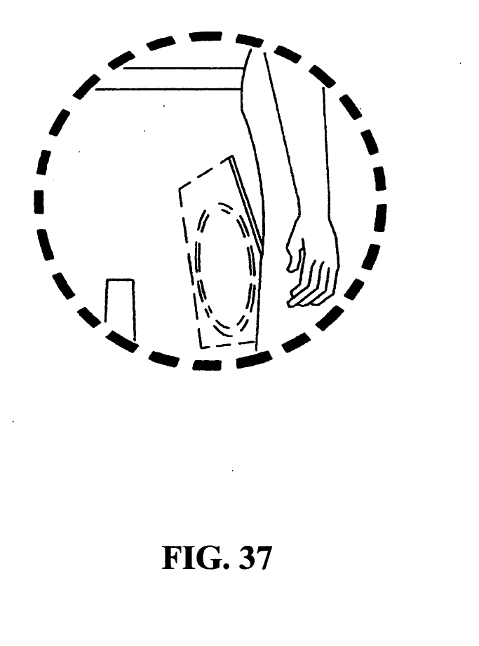

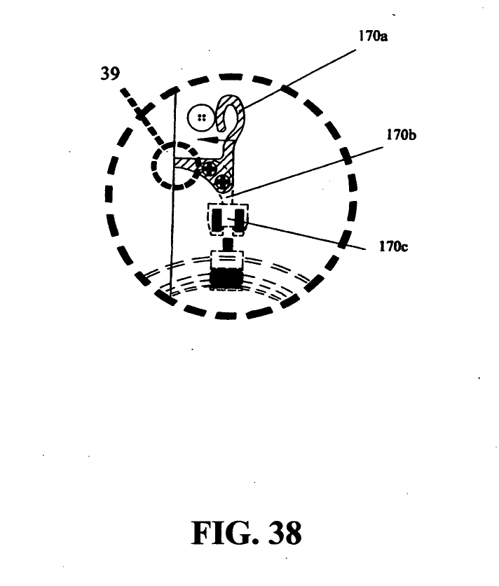

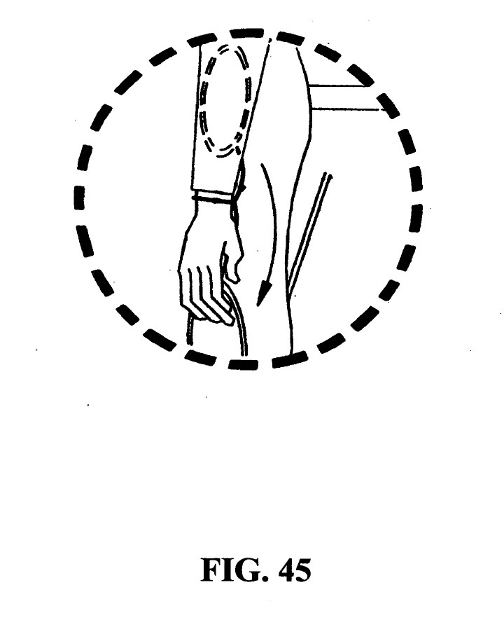

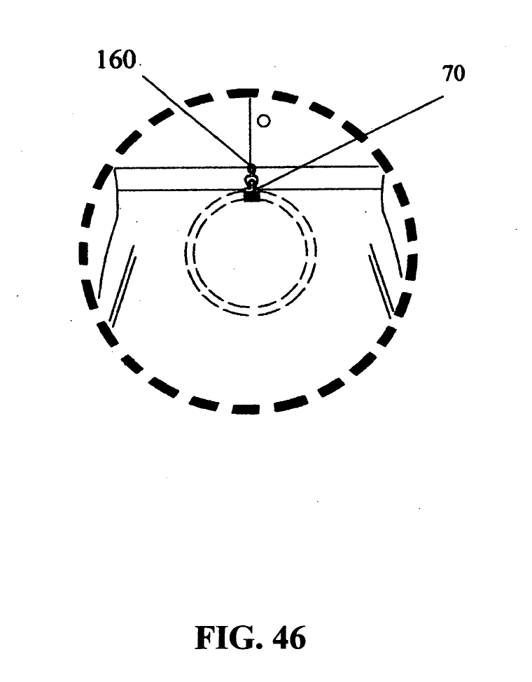

Referring to FIG. 36, a variety of ways of equipping a person with the present invention is shown, with cutouts giving further detail in FIG. 37, FIG. 38, FIG. 45 and FIG. 46.

Referring to FIG. 37, detail is shown of the present invention within a person's pants pocket.

Referring to FIG. 38, detail is shown of one embodiment of an attachment arrangement, showing hooked magnetic hoop support 170, hooked external support 170a, internal support 170b, and magnetic end 170c. A cutout is shown in order to give further detail in FIG. 19.

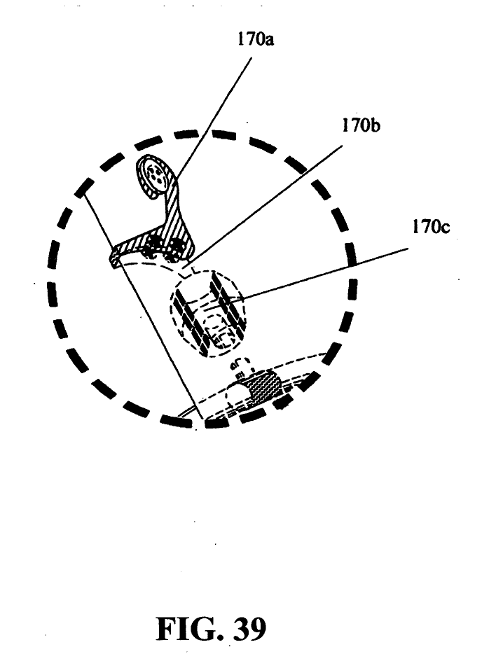

Referring to FIG. 39, hooked magnetic hoop support 170 is shown in detail, highlighting hooked external support 170a, internal support 170b, and magnetic end 170c.

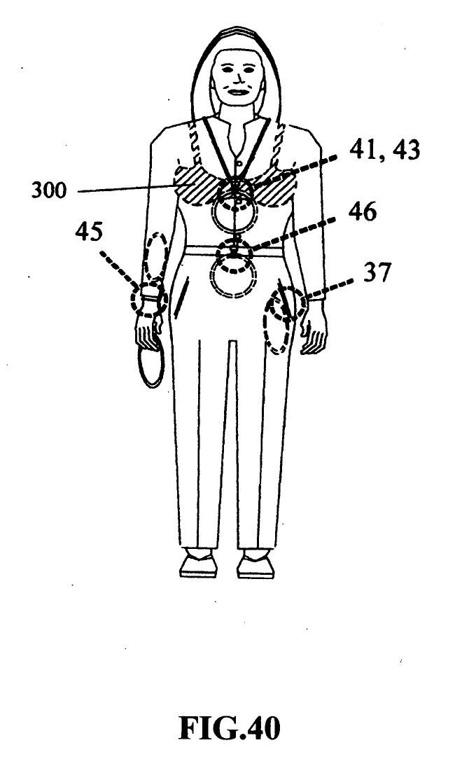

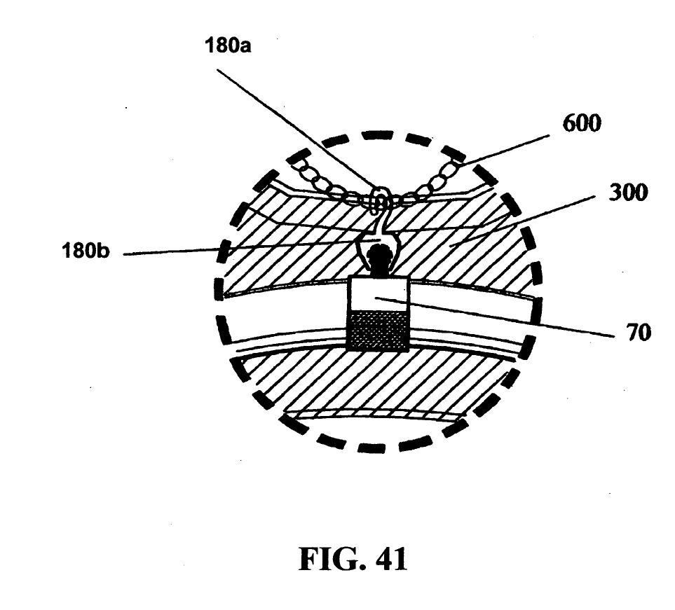

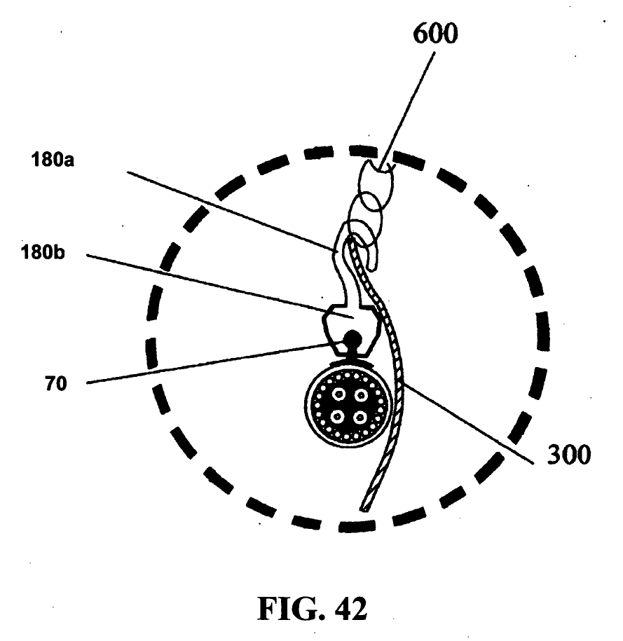

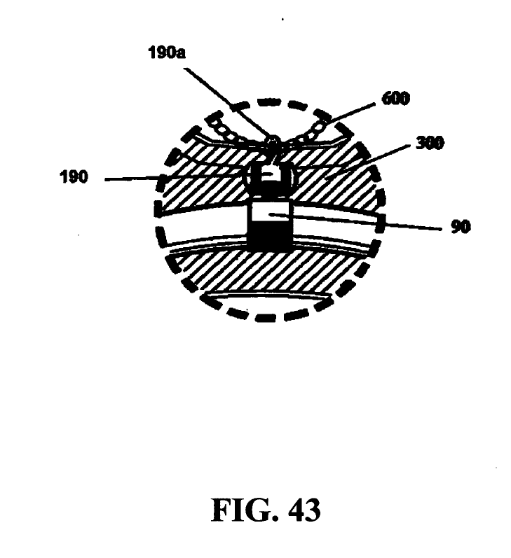

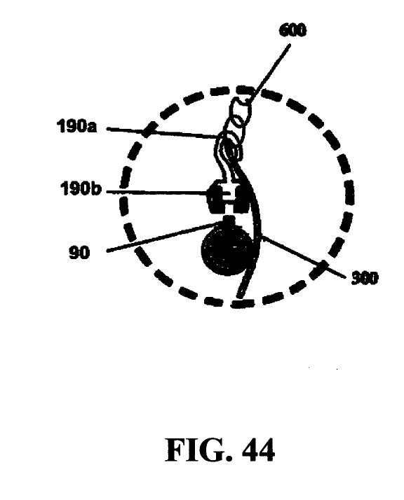

Referring to FIG. 40, supporting brassiere 300 is shown. Cutouts are provided in order to give further detail in FIG. 41, FIG. 42, FIG. 43, FIG. 44, FIG. 45, FIG. 46, and FIG. 37.

Referring to FIG. 41, detail is shown of an embodiment of the components strap-on male assembly 70, hooked support 180a, female connector end 180b, supporting brassiere 300, and supporting necklace 600.

Referring to FIG. 42, detail is a side view of an embodiment of the components strap-on male assembly 70, hooked support 180a, female connector end 180b, supporting brassiere 300, and supporting necklace 600.

Referring to FIG. 43, detail is shown of an embodiment of the components strap-on magnetic assembly 90, hooked support 190a, magnetic female end 190b, supporting brassiere 300, and supporting necklace 600.

Referring to FIG. 44, detail is a side view of an embodiment of the components strap-on male magnetic assembly 90, hooked support 190a, magnetic female end 190b, supporting brassiere 300, and supporting necklace 600.

Referring to FIG. 45, detail is shown of the deployment of one embodiment of the present invention.

Referring to FIG. 46, detail is shown of an embodiment of the components strap-on male assembly 70 and hooked female connector 160.

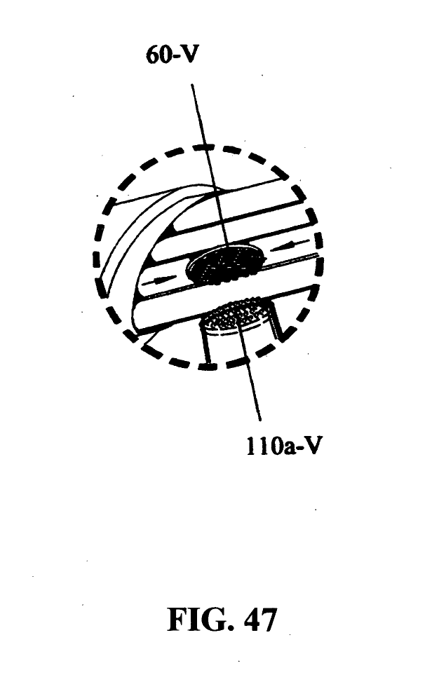

Referring to FIG. 47, male Velcro connector 60-V is shown ready to click into female Velcro cord end 110a-V.

The preferred heat shrink fabric to make the final layer of the core is polyester since it shrinks together, fuses smooth and melts at 500 degrees. Fusion ribbon is used to accomplish bonding. When at the fusion temp, e.g. 325 degrees, the spontaneously liquefying (dispersing) ribbon of hot glue material will bond the seams. This is accomplished by applying the hot glue material on the outside and inside the layers. When an encapsulating fabric is subjected to a vacuum when near the fusion temperature, the ribbon of glue will bond the multiple layers together while remaining flexible. This creates a seam that will not split open. An alternative is to cover a synthetic fiber filler pad (cushion) under a quilted, zip-on, fabric cover. This embodiment allows for un-zipping and cleaning the ring cover in the wash.

The preferred process of using the present invention for restraining is as follows:
Obtaining a restraining-protecting-lifting device
Placing the restraining-protecting-lifting device into the user's pants pocket
Removing the restraining-protecting-lifting device from the user's pants or jacket pocket
Placing the restraining-protecting-lifting device on the wrists of the desired subject.

The preferred process of using the present invention for protection is as follows:
Obtaining a restraining-protecting-lifting device
Inserting the user's wrist into the loop attached to the cord
Placing the restraining-protecting-lifting device between the user's forearm and long shirt sleeve; and,
Removing the restraining-protecting-lifting device from the user's long shirt sleeve then placing onto the desired suspect's arms or legs.

The preferred process of using the present invention for lifting the extremities of a person is as follows:
Obtaining a restraining-protecting-lifting device 100, interlinked to larger or smaller device 200;
Slipping the restraining-protecting-lifting device up to the knee of the nursing/therapy patient; and,
Lifting the legs of the desired subject by exerting upward force with the user's hand or forearm inside the restraining-protecting-lifting device, or
Slipping the restraining-protecting-lifting device 200 up to shoulder of the upper arm of the nursing/therapy patient; and,
Lifting shoulder of the desired subject by exerting upward force with the user's hand or forearm inside the restraining-protecting-lifting device 100.

The process of making the present invention is as follows:
Obtaining a strand of cable, wiring of any gauge having multiple internal wires, or substitutes, e.g. clothes line, synthetic cords;
Splicing together the internal wires, wiring, or substitutes at the ends of the cable to form the single strand of cable, wiring or substitute into a hoop with a diameter between 2″ and 7″;
Installing the male connector insert at the splice using the strand ends;
Covering the core hoop with a layer of polyester cloth;
Covering the polyester cloth with a thin rubber layer;
Applying a seamless antiseptic coating over the layer of material to form a restraining-protecting-lifting device; and,
Clicking the flexible tether male end into the female connector.

Other embodiments, uses and advantages of the present invention will be apparent to those skilled in the art from consideration of the specification and practice of the invention disclosed herein. The specification and examples should be considered exemplary only.

What is claimed is:

1) A restraining-protecting-lifting device formed into a hoop wherein said hoop is comprised of an inner core, multiple layers of material and a seamless outer cover, wherein said seamless outer cover encases said inner core.

2) The restraining-protecting-lifting device of claim 1, wherein the inner core is comprised of a single strand of tubular material from the group comprised of cable, wiring, clothes line, synthetic cord, stainless anchor cable, sheathed cable, rubber tubing, plastic tubing, cotton cord, jute cord and nylon cord.

3) The restraining-protecting-lifting device of claim 1, wherein the inner core is comprised of multiple strands from the group comprised of cable, wiring, clothes line, synthetic cord.

4) The restraining-protecting-lifting device of claim 3, further comprising strands of wire wound around said multiple strands of cable.

5) The restraining-protecting-lifting-device of claim 4 further comprising means for retrieving said restraining-protecting-lifting device once it is propelled toward a target.

6) The restraining-protecting-lifting device of claim 5, wherein said means for retrieving is permanently affixed to said restraining-protecting-lifting device.

7) The restraining-protecting-lifting device of claim 5, wherein said means for retrieving said restraining-protecting-lifting device is releasable.

8) A method of making a restraining-protecting-lifting device, comprising:
Obtaining a strand of cable having multiple internal wires with multiple wire ends;
Splicing together said multiple internal wires at said multiple wire ends in order to form a single strand of cable into a loop with a diameter between 2″ and 7″;
Covering said loop with a layer of material; and,
Applying a seamless antiseptic coating to said layer of material to form a restraining-protecting-lifting device.

9) A method of using a restraining-protecting-lifting device, comprising:
Obtaining a restraining-protecting-lifting device;
Inserting the user's wrist into a loop attached to a cord;
Placing the restraining-protecting-lifting device between the user's lower arm and the user's shirt sleeve;
Removing said restraining-protecting-lifting device from said user's shirt sleeve; and
Throwing said restraining-protecting-lifting device at a desired subject.
